(19) United States
(12) Patent Application Publication
(10) Pub. No.: US 2022/0131986 A1
(43) Pub. Date: Apr. 28, 2022

(54) INFORMATION PROCESSING APPARATUS, DISPLAY METHOD, AND NON-TRANSITORY COMPUTER-EXECUTABLE MEDIUM

(71) Applicant: Yuuya Nakao, Kanagawa (JP)

(72) Inventor: Yuuya Nakao, Kanagawa (JP)

(73) Assignee: Ricoh Company, Ltd., Tokyo (JP)

(21) Appl. No.: 17/450,728

(22) Filed: Oct. 13, 2021

(30) Foreign Application Priority Data
Oct. 27, 2020 (JP) 2020-179687

(51) Int. Cl. H04N 1/00

(52) U.S. Cl. CPC H04N 1/00395; H04N 1/00514; H04N 1/00411

(57) ABSTRACT

An information processing apparatus includes circuitry. The circuitry displays a help screen including help content relating to a first function and information for receiving a setting relating to a second function, which is different from the first function. The circuitry updates a setting value of the second function in response to the received setting.

### CROSS-REFERENCE TO RELATED APPLICATION

This patent application is based on and claims priority pursuant to 35 U.S.C. § 119(a) to Japanese Patent Application No. 2020-179687, filed on Oct. 27, 2020, in the Japan Patent Office, the entire disclosure of which is hereby incorporated by reference herein.

### BACKGROUND

### Technical Field

Embodiments of the present disclosure relate to an information processing apparatus, a display method, and a non-transitory computer-executable medium.

### Related Art

Apparatuses are known that facilitate transition from a help screen for functions to a setting screen. For example, operation apparatuses are known that, in response to registration of a shortcut key corresponding to a setting item, when displaying an operation screen, display a shortcut key corresponding to the setting item on the operation screen in a manner that the shortcut key is selectable.

### SUMMARY

An embodiment of the present disclosure includes an information processing apparatus including circuitry. The circuitry displays a help screen including help content relating to a first function and information for receiving a setting relating to a second function, which is different from the first function. The circuitry updates a setting value of the second function in response to the received setting.

An embodiment of the present disclosure includes a display method including displaying a help screen including help content relating to a first function and information for receiving a setting relating to a second function, which is different from the first function, and updating a setting value of the second function in response to the received setting.

An embodiment of the present disclosure includes a non-transitory computer-executable medium storing a program storing instructions which, when executed by a computer, causes the computer to display a help screen including help content relating to a first function and information for receiving a setting relating to a second function, which is different from the first function, and update a setting value of the second function in response to the received setting.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of an image forming system, according to embodiments of the present disclosure;

FIG. 2 is a diagram illustrating an example of a hardware configuration of an image forming apparatus, according to embodiments of the present disclosure;

FIG. 3 is a block diagram illustrating an example of a functional configuration of the image forming apparatus, according to embodiments of the present disclosure;

FIG. 4 is a sequence diagram illustrating an example of an operation of displaying a help list screen, according to embodiments of the present disclosure;

FIG. 5 is an illustration of an example of a help list screen, according to embodiments of the present disclosure;

FIG. 6 is a sequence diagram illustrating an example of an operation of displaying a setting screen, according to embodiments of the present disclosure;

FIG. 7 is an illustration of an example of a help detail screen, according to embodiments of the present disclosure;

FIG. 8 is an illustration of an example of a setting screen, according to embodiments of the present disclosure;

FIG. 9 is an illustration of another example of the help detail screen, according to embodiments of the present disclosure;

FIG. 10 is a sequence diagram illustrating an example of an operation of changing a setting, according to embodiments of the present disclosure;

FIG. 11 is a diagram illustrating an example of temporary update information, according to embodiments of the present disclosure;

FIG. 12 is an illustration of an example of a notification email, according to embodiments of the present disclosure; and

FIG. 13 is an illustration of an example of an update confirmation screen, according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

Embodiments of an image forming apparatus as an example of an information processing apparatus according to the present disclosure are described with reference to the drawings.

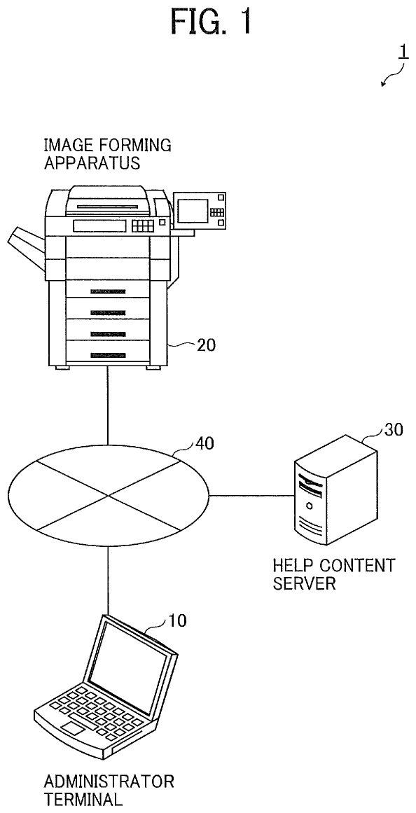

FIG. 1 is a diagram illustrating an example of a system configuration of an image forming system 1.

The image forming system 1 according to the present embodiment includes an administrator terminal 10, an image forming apparatus 20, and a help content server 30. The administrator terminal 10, the image forming apparatus 20, and the help content server 30 are communicably connected through a communication network 40.

The administrator terminal 10 is a terminal operated by an administrator, who manages the image forming apparatus 20. For example, the administrator terminal 10 receives a notification from the image forming apparatus 20 and displays a content of the notification content on a screen. In this case, the administrator terminal 10 may receive an email transmitted from the image forming apparatus 20 via an email server, for example. Further, the administrator terminal 10 receives an operation by the administrator on the displayed screen and transmits information indicating a content of the operation to the image forming apparatus 20.

The image forming apparatus 20 is an apparatus having a function of forming an image. The image forming apparatus 20 performs processing defined in an application program for each function in response to an operation by a user (operator). Further, the image forming apparatus 20 displays a help screen relating to each function.

Specifically, in response to receiving the user's operation requesting display of a help screen, the image forming apparatus 20 acquires a help content relating to how to operate a function currently being displayed from the help content server 30 and displays the acquired help content. Furthermore, the image forming apparatus 20 displays a shortcut button to a setting screen relating to the help content and receives a change of a setting value on the setting screen that is displayed in response to selection of the shortcut button.

When a setting value for which the user does not have authorization for changing is changed, the image forming apparatus 20 transmits a notification indicating the change to the administrator. Further, the image forming apparatus 20 receives a selection of whether to rechange the changed setting value to the previous setting value or to permanently reflect the changed setting value via the administrator terminal 10.

The help content server 30 manages help contents. Specifically, the help content server 30 stores a help content for each function of the image forming apparatus 20. In response to receiving a transmission request in which a specific function is designated from the image forming apparatus 20, the help content server 30 transmits a help content relating to the designated function.

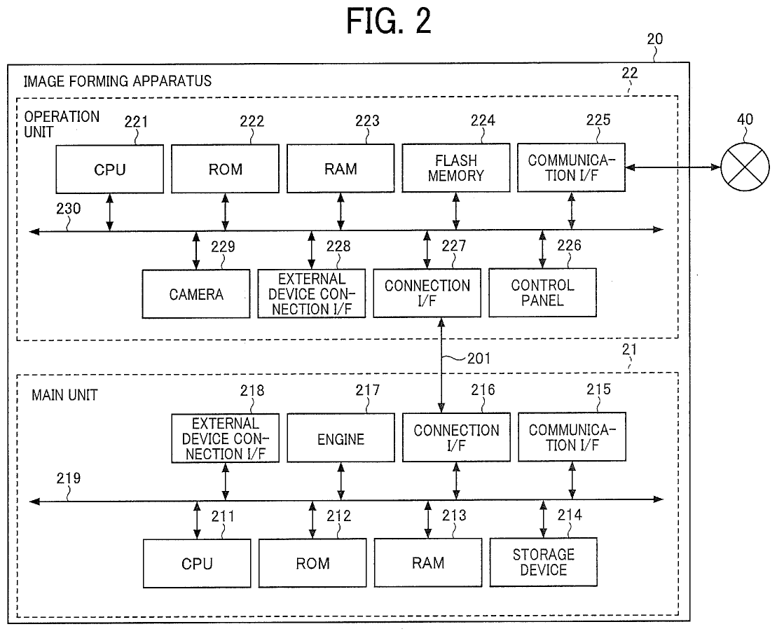

FIG. 2 is a block diagram illustrating an example of a hardware configuration of the image forming apparatus 20.

The image forming apparatus 20 includes a main unit 21 that implements an image forming function, and an operation unit 22 that receives a user operation. Receiving a user operation includes receiving or accepting information or data input according to an operation performed by a user. Such information or data includes a signal indicating a coordinate value on a screen, for example.

The main unit 21 and the operation unit 22 are communicably connected to each other through a communication path 201. The communication path 201 may be in compliance with a universal serial bus (USB) standard, for example. The communication path 201 may be of a standard other than the USB standard regardless of whether the communication path 201 is wired or wireless.

The main unit 21 includes, for example, a central processing unit (CPU) 211, a read only memory (ROM) 212, a random access memory (RAM) 213, a storage device 214, a communication interface (I/F) 215, a connection I/F 216, an engine 217, an external device connection I/F 218, and a system bus 219.

The CPU 211 is an arithmetic device that loads programs stored in, for example, the ROM 212 or the storage device 214 onto the RAM 213 as a work area, to execute the programs to control overall operation of the main unit 21. For example, the CPU 211 controls the engine 217 to implement various functions such as a copier function, a scanner function, a facsimile function, and a printer function.

The ROM 212 is a nonvolatile memory that stores, for example, a Basic Input/Output System (BIOS), which is executed when the main unit 21 is started, and various settings. The RAM 213 is a volatile memory used as a work area for the CPU 211. The storage device 214 is a nonvolatile storage device that stores, for example, an operating system (OS), an application program, and various data. The storage device 214 is implemented by, for example, a hard disk drive (HDD) or a solid state drive (SSD).

The communication I/F 215 is a network interface such as a wireless local area network (LAN) or a wired LAN that allows the main unit 21 to communicate with an external device. The connection I/F 216 is an interface that allows the main unit 21 to communicate with the operation unit 22 through the communication path 201.

The engine 217 is hardware that performs processing other than general-purpose information processing and data communications. For example, the engine 217 performs processing for implementing the copier function, the scanner function, the facsimile function, and the printer function. The engine 217 includes, for example, a scanner that scans and reads an image on a document, a plotter that performs printing on sheet materials such as a sheet of paper, and a facsimile device that performs facsimile communication. The engine 217 may further include optional equipment such as a finisher that sorts printed sheets, or an automatic document feeder (ADF) that automatically feeds documents to be scanned.

The external device connection I/F 218 is an interface that connects the main unit 21 to an external device. The system bus 219 is connected to the above-described components and transmits address signals, data signals, and various control signals, for example.

The operation unit 22 is implemented by a computer. The operation unit 22 includes, for example, a CPU 221 and a ROM 222, a RAM 223, a flash memory 224, a communication I/F 225, a control panel 226, a connection I/F 227, an external device connection I/F 228, a camera 229, and a system bus 230.

The CPU 221 is an arithmetic device that loads programs stored in, for example, the ROM 222 or the flash memory 224 onto the RAM 223 as a work area, to execute the programs to control overall operation of the operation unit 22. The ROM 222 is, for example, a nonvolatile memory that stores, for example, a BIOS, which is executed when the operation unit 22 is started, and various settings. The RAM 223 is a volatile memory used as a work area for the CPU 221. The flash memory 224 is a nonvolatile storage device that stores, for example, an OS, an application program, and various data.

The communication I/F 225 is a network interface such as a wireless LAN or a wired LAN. The communication I/F 225 connects the operation unit 22 to the communication network 40, to allow the operation unit to communicate with an external apparatus such as the administrator terminal 10 or the help content server 30.

The control panel 226 receives various inputs made through user operation and displays various information. The control panel 226 is implemented by, for example, a liquid crystal display (LCD) having a touch panel function. However, this configuration is merely one example. In another example, the control panel 226 is implemented by an organic electroluminescence (EL) display device having a touch panel function. In still another example, in addition or in alternative to the above-described LCD or organic EL, the control panel 226 includes an operation unit such as hardware keys, a display unit such as an indicator lamp, or both.

The connection I/F 227 is an interface that allows the operation unit 22 to communicate with the main unit 21 through the communication path 201. The external device connection I/F 228 is an interface such as a USB that connects the operation unit 22 to an external device.

The camera 229 is a photographing device that captures an image of a user. In another example, the camera 229 is external to the image forming apparatus 20 and connected to the operation unit 22 through the external device connection I/F 228. The system bus 230 is connected to the above-described components and transfers an address signal, a data signal, various control signals. Each of the help content server 30 and the administrator terminal 10 is implemented by, for example, a general-purpose computer. The general-purpose computer includes, for example, a CPU, a memory such as a ROM, RAM, SSD, or HDD, a display, an input device, and a network interface. In another example, at least one of the input device or the display is omitted in the help content server 30. In still another example, the help content server 30 is implemented by one or more general-purpose computers. The help content server 30 may reside on the Internet or may be on-premises. When residing on the Internet, the help content server 30 may support cloud computing.

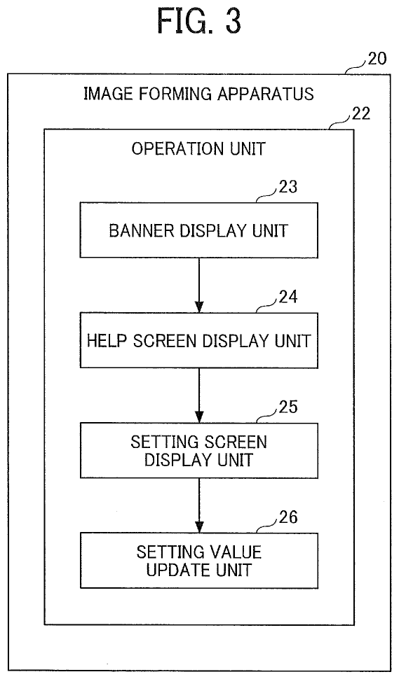

FIG. 3 is a block diagram illustrating an example of a functional configuration of an image forming apparatus.

The operation unit 22 of the image forming apparatus 20 includes a banner display unit 23, a help screen display unit 24, a setting screen display unit 25, and a setting value update unit 26.

The banner display unit 23 displays a banner on the control panel 226. The banner is a stipe-shaped image included in an upper area or a lower area of a screen displayed on the control panel 226. The banner display unit 23 displays a banner common to multiple functions according to a login state of a user. For example, a banner displayed on the upper area of an operation screen includes a help button, which when selected, causes a currently displayed screen to transition to a help screen, regardless of which function is currently being displayed. In response to pressing of the help button, the banner display unit 23 sends a notification indicating that the help button is pressed to the help screen display unit 24.

The banner display unit 23 is a functional unit that executes processing defined in a banner application.

In response to receiving a help content corresponding to a function that is currently being displayed from the help content server 30, the help screen display unit 24 displays the help screen including a help content and a shortcut button on the control panel 226. The shortcut button is an example of reference information for causing a screen to transition to a setting screen relating to a second function different from a function to be supported by the help screen. In the following description, the function to be supported by the help screen may be referred to as a “first function.” The setting relating to the second function may include a setting of the main unit 21 of the image forming apparatus 20.

For example, the shortcut button includes path information indicating a location of an application program (initial setting application described below) configuring the setting screen display unit 25 that displays the setting screen. In another example, the help screen includes a shortcut button, that when selected, causes a screen to transition to a setting screen relating to the first function.

Further, information for identifying one or more setting items relating to the help content is embedded in the shortcut button. In the following description, the information for identifying one or more setting item relating to the help content may be referred to as “setting item information.” The setting item information is an identifier indicating one or multiple setting items. For example, in the shortcut button that is displayed with a help content “How to not automatically delete stored documents” in a document management function, an identifier indicating “a setting of automatic deletion of documents” is embedded.

The help screen display unit 24 is a functional unit that executes processing defined in a help application.

In response to pressing of the shortcut button on the help screen is pressed, the setting screen display unit 25 displays a setting screen for changing a setting value corresponding to the setting item information embedded in the shortcut button. When other setting items are included in the setting screen, the setting screen display unit 25 hides the other setting items or displays the other setting items in a manner that the other setting items are unchangeable. In other words, on the setting screen, an input is receivable (acceptable) to only the setting item relating to the help content.

The setting screen display unit 25 is a functional unit that executes processing defined in an initial setting application.

The setting value update unit 26 updates a setting value to a value input on the setting screen. The setting value update unit 26 applies different update processing according to an access authorization assigned to a user who inputted the setting value for update. Specifically, when the access authorization assigned to the user is an administrator authorization, the setting value update unit 26 updates the setting value. This update processing is performed in the known way.

By contrast, when the access authorization assigned to the user is not the administrator authorization, the setting value update unit 26 temporarily updates the setting value and transmits a notification indicating the update to the administrator. Further, the setting value update unit 26 receives a selection by the administrator whether to change the input setting value back to the previous setting value or update the setting value to permanently reflect the input setting value. The setting value update unit 26 changes the input setting value to the previous setting value or updates the setting value to permanently reflect the input setting value in accordance with the received selection.

The setting value update unit 26 is a functional unit that executes processing defined in a control application. The setting value update unit 26 may function as a controller that controls overall operation of the image forming apparatus 20. For example, the setting value update unit 26 may execute user login authentication.

The banner display unit 23, the help screen display unit 24, the setting screen display unit 25, and the setting value update unit 26 are implement by the CPU 221 illustrated in FIG. 2 that operates in cooperation with, for example, the ROM 222, the RAM 223, the communication I/F 225, and the control panel 226.

A description is given below of operation of the image forming system 1 according to the present embodiment.

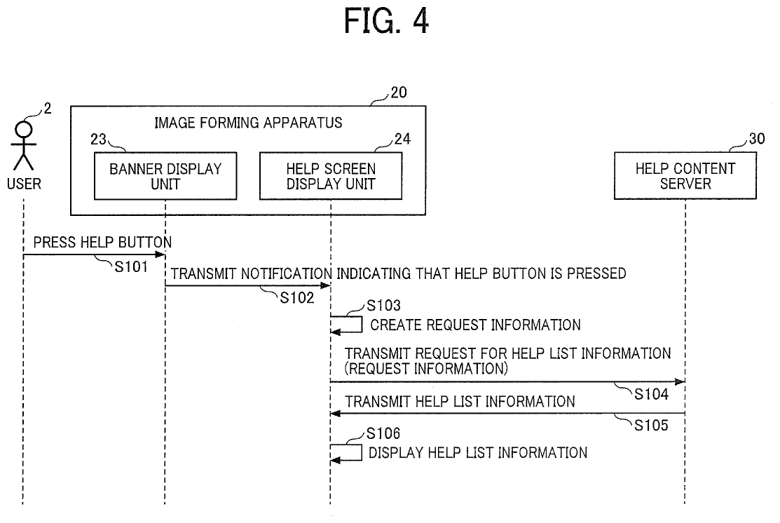

FIG. 4 is a sequence diagram illustrating an example of an operation of displaying a help list screen.

In response to receiving a user's pressing of the help button on an operation screen of a given function (step S101), the banner display unit 23 sends a notification indicating the pressing of the help button to the help screen display unit 24 (step S102).

The help screen display unit 24 creates request information (step S103). The request information is information used in identifying a help content. For example, the request information is information indicating a model of the image forming apparatus 20, a function to be supported by the help content and/or a designation of language.

The help screen display unit 24 transmits information requesting transmission of help list information to the help content server 30 together with the request information (step S104). The help content server 30 generates the help list information based on the request information and transmits the help list information to the help screen display unit 24 (step S105). The help list information is list information including titles of one or more help contents.

The help screen display unit 24 displays the help list screen based on the received help list information (step S106).

In another example, in step S105, the help content server 30 transmits address information of a server to be redirected. For example, when the help content is recorded in multiple servers that support different language respectively, the help content server 30 transmits address information of a certain server that supports a designated language. In this case, the help screen display unit 24 redirects to the certain server indicated by the address information to transmit the request information to the certain server, and receives the help list information from the certain server.

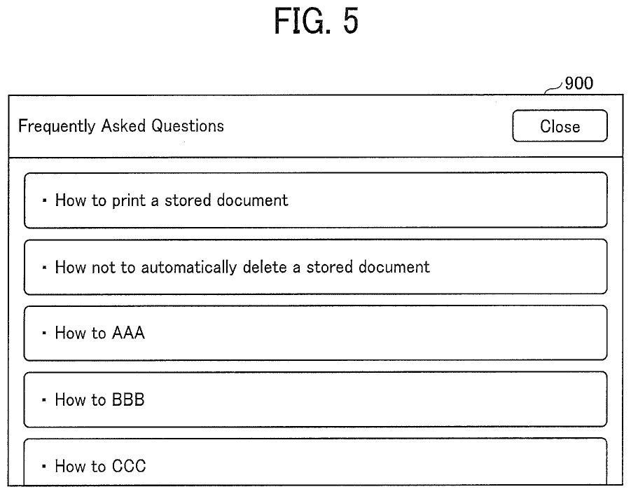

FIG. 5 is an illustration of an example of the help list screen.

A help list screen 900 includes a list display of titles of help contents relating to a function being displayed when the help button is pressed. The function being displayed when the help button is pressed is an example of a first function. For example, the help list screen 900 illustrated in FIG. 5 includes a list display of titles of help contents relating to the document management function.

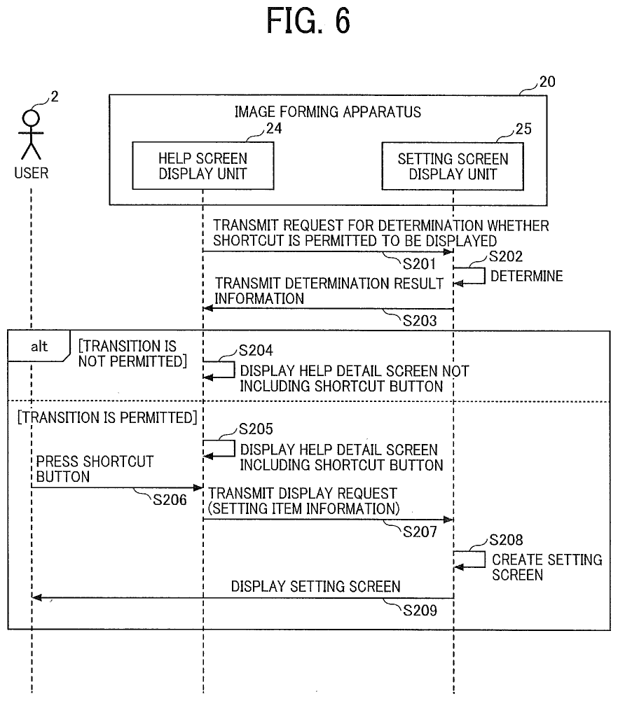

FIG. 6 is a sequence diagram illustrating an example of an operation of displaying a setting screen.

In response to receiving a selection of the title of a given help content on the help list screen 900 from a user 2, the help screen display unit 24 sends, to the setting screen display unit 25, a requests to determine whether display of a shortcut to a setting screen relating to the given help content is available (step S201).

The setting screen display unit 25 determines whether transition to the setting screen relating to the given help content by the shortcut display is available (step S202). Specifically, when there is no setting item relating to the given help content, or when the setting value relates to, for example, billing or erroneous transmission, the setting screen display unit 25 determines that the screen transition is unavailable. In another example, whether the transition to the setting screen is available is defined in advance as a flag for each setting item.

The setting screen display unit 25 sends information indicating the determination result to the help screen display unit 24 (step S203). When the determination result indicates that transition is unavailable, the help screen display unit 24 displays the help detail screen that includes no shortcut button (step S204).

When the determination result indicates that transition is available, the help screen display unit 24 displays a help detail screen including a shortcut button (step S205). The help screen display unit 24 embeds the setting item information in the shortcut button.

Subsequently, when in response to receiving pressing of the shortcut button by the user 2 (step S206), the help screen display unit 24 sends the setting item information embedded in the shortcut button, to request the setting screen display unit 25 to display the setting screen (step S207).

The setting screen display unit 25 generates a setting screen based on the setting item information (step S208) and displays the generated setting screen on the control panel 226 (step S209).

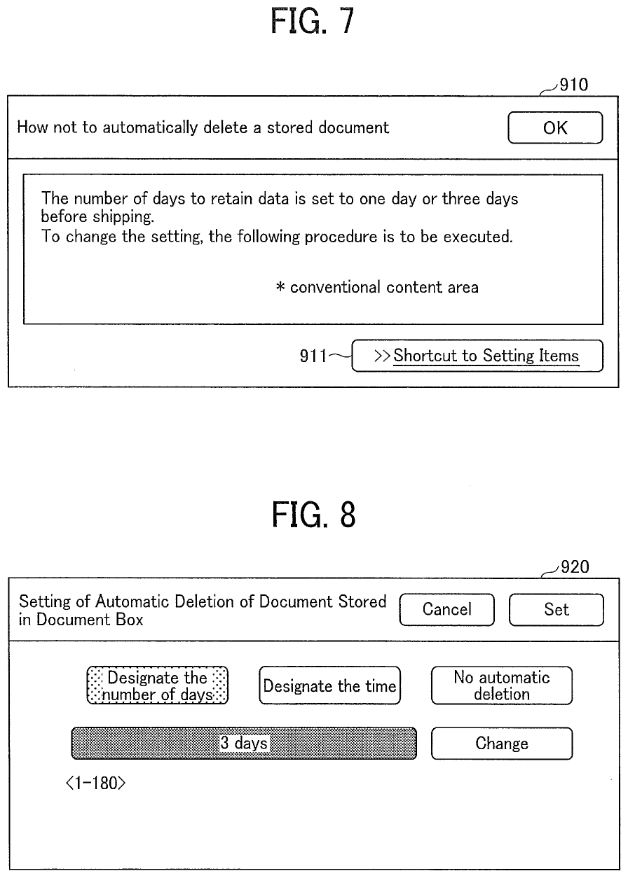

FIG. 7 is an illustration of an example of the help detail screen.

A help detail screen 910 includes a shortcut button 911. In the example of FIG. 7, the shortcut button 911 is included in the lower part of an area in which the help content is displayed. The shortcut button 911 may be included in any other positions than the position illustrated in FIG. 7.

In response to pressing of the shortcut button 911, the setting screen display unit 25 displays the setting screen. The shortcut button 911 is an example of information for receiving a setting relating to a second function, which is different from the first function.

FIG. 8 is an illustration of an example of the setting screen.

On a setting screen 920, the value of the setting item indicated by the setting item information is displayed in a manner that an input to change the value can be received. A value of a setting item that is not indicated by the setting item information may be hidden or may be displayed in a manner that an input to change the value is not to be received.

In response to an input of a setting value on the setting screen 920, the image forming apparatus 20 performs an operation of changing a setting as described below.

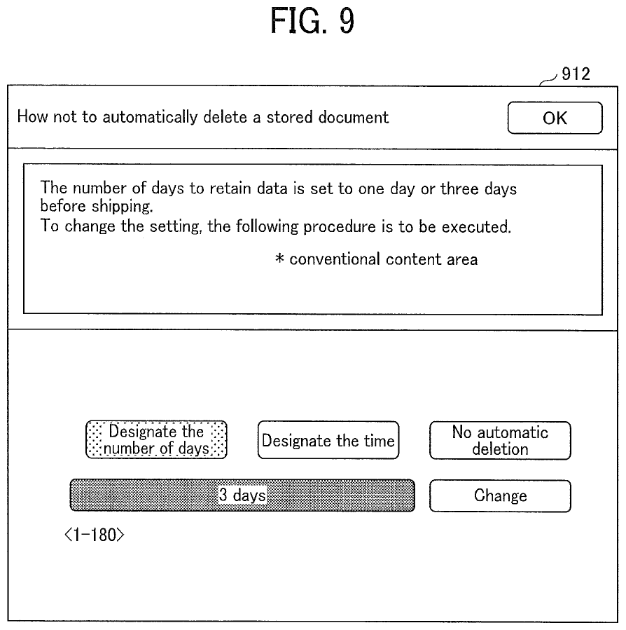

FIG. 9 is an illustration of another example of the help detail screen.

A help detail screen 912 includes an input field that receives an input of a value of the setting item indicated by the setting item information. The image forming apparatus 20 receives an input of the setting value on the help detail screen 912 in substantially the same manner as described above with reference to the setting screen 920. In response to receiving the input of the setting value on the help detail screen 912, the image forming apparatus 20 performs an operation of changing a setting as described below in substantially the same manner as in response to receiving the input of the setting value on the setting screen 920. The input field that receives the input of the setting value displayed on the help detail screen 912 is another example of information for receiving a setting relating to the second function, which is different from the first function.

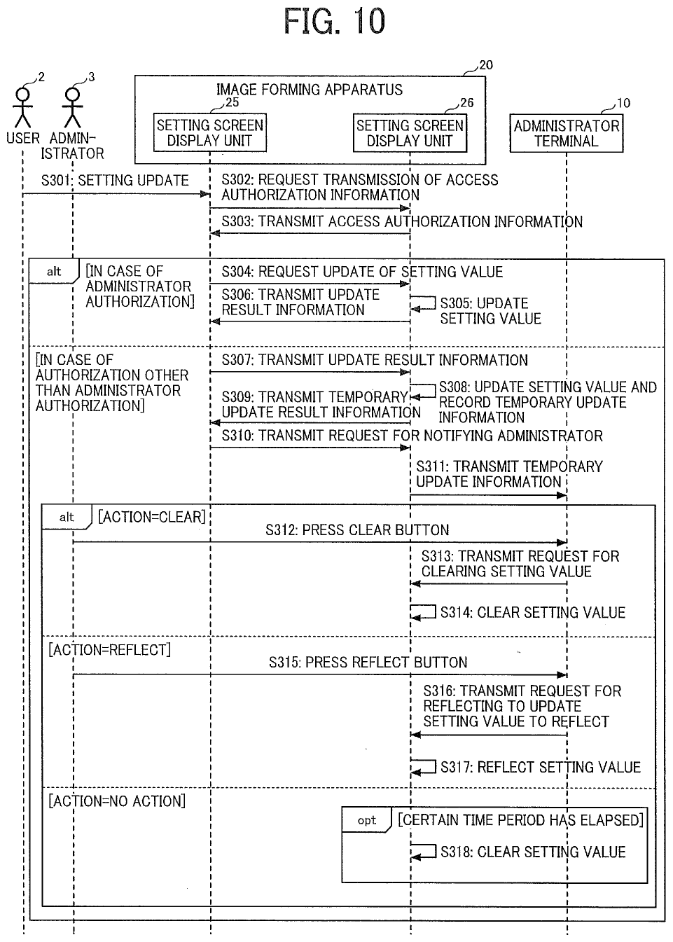

FIG. 10 is a sequence diagram illustrating an example of an operation of changing a setting.

In response to receiving an operation of updating a setting value from the user 2 (step S301), the setting screen display unit 25 sends, to the setting value update unit 26, a request to send access authorization information of the user 2 (step S302). The setting value update unit 26 sends the access authorization information of the user 2 to the setting screen display unit 25 (step S303).

The access authorization information is information indicating an access authorization assigned to each user and is stored in, for example, the storage device 214 of the main unit 21. The access authorization information includes information indicating whether an access authorization assigned to the user is the administrator authorization. The description is made on the assumption that the setting value update unit 26 holds the access authorization information of the user 2 in advance through login authentication.

When the access authorization of the user 2 is the administrator authorization, the setting screen display unit 25 sends, to the setting value update unit 26, a request to update the setting value (step S304). The setting value update unit 26 updates the setting value (step S305). In this case, the setting value update unit 26 applies a known setting value updating processing.

The setting value update unit 26 sends information indicating the update result to the setting screen display unit 25 (step S306). Then, the operation ends.

By contrast, when the access authorization of the user 2 is not the administrator authorization, the setting screen display unit 25 sends, to the setting value update unit 26, a request to temporarily update the setting value (step S307). The setting value update unit 26 temporarily updates the setting value. Specifically, the setting value update unit 26 updates the setting value and records temporary update information (step S308). The temporary update information is information indicating temporary update of the setting value.

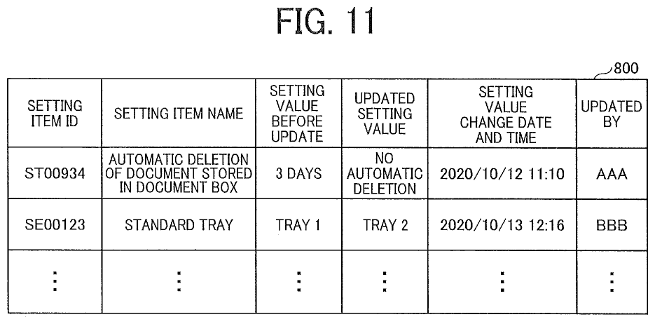

FIG. 11 is a diagram illustrating an example of the temporary update information.

Temporary update information 800 includes, as items, a setting item identifier (ID), a setting item name, a setting value before update, an updated setting value, and a setting change date and time.

The value of the item “setting item ID” is an identifier identifying a setting item.

The value of the item “setting item name” is a name of a setting item.

The value of the item “setting value before update” is a value before the setting value is changed. The value of the item “setting value before update” is used when the setting value is changed back to the previous value in response to the administrator's operation.

The value of the item “updated setting value” is a value after the setting value is changed.

The value of the item “setting change date and time” is a value indicating a date and time when the setting value is changed.

Referring again to FIG. 10, the setting value update unit 26 sends information indicating a result of the temporary update to the setting screen display unit 25 (step S309). The setting screen display unit 25 sends, to the setting value update unit 26, a requests to transmit a notification to an administrator 3 (step S310). The setting value update unit 26 transmits the temporary update information to the administrator terminal 10 (step S311).

In step S311, the setting value update unit 26 may transmit the temporary update information to the administrator terminal 10 when the temporary update information can be transmitted to the administrator terminal 10. In another example, in step S311, the setting value update unit 26 transmits a notification email containing the temporary update information addressed to the administrator's email address to an email server, for example. In this case, the administrator terminal 10 receives the notification email stored in, for example, the email server in response to an operation by the administrator 3 to receive emails. The administrator 3 is a user having the administrator authorization. In the processes of step S307 to step S318, the administrator 3 is a person different from the user 2 because the user 2 has no administrator authorization.

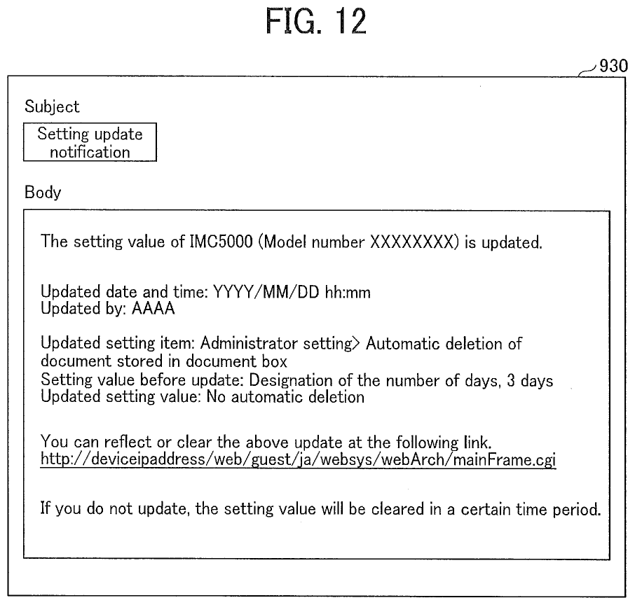

FIG. 12 is an illustration of an example of the notification email.

A notification email 930 includes the temporary update information in the body of the email. The body of the notification email 930 may further include information identifying the image forming apparatus 20 (e.g., a model number). In this case, in step S311, the setting value update unit 26 transmits the temporary update information including information identifying the image forming apparatus 20 to, for example, the administrator terminal 10 or the email server.

The body of the notification email 930 further includes a link for causing the screen to transition to an update confirmation screen. The update confirmation screen is a screen for selecting whether to reflect the update or clear (undo) the update. In response to pressing of the link by the administrator 3, the administrator terminal 10 displays the update confirmation screen.

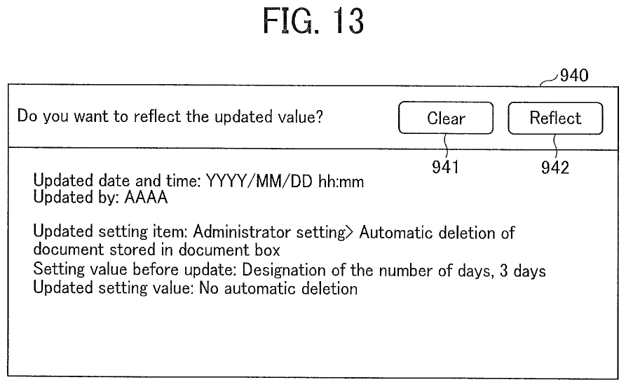

FIG. 13 is an illustration of an example of the update confirmation screen.

An update confirmation screen 940 includes a clear button 941 and a reflect button 942. Preferably, the update confirmation screen 940 further includes the values of the respective items of the temporary update information. In another example, the update confirmation screen 940 may include other information.

Referring again to FIG. 10, in response to pressing of the clear button 941 on the update confirmation screen 940 by the administrator 3 (step S312), the administrator terminal transmits a request to clear the setting value (change the setting value back to the previous value) to the image forming apparatus 20 (step S313).

The setting value update unit 26 clears the setting value (step S314). In other words, the setting value update unit 26 changes the updated setting value back to the previous value. Specifically, the setting value update unit 26 updates the value of the setting item to the value of the item “setting value before update” of the temporary update information 800 illustrated in FIG. 11, and deletes the corresponding record of the temporary update information 800. This prevents a permanent update of a setting value that is not recognized by the administrator 3, whereby improving convenience and ensuring safety at the same time.

On the other hand, in response to pressing of the reflect button 942 on the update confirmation screen 940 by the administrator 3 (step S315), the administrator terminal 10 transmits a request to reflect the setting value to the image forming apparatus 20 (step S316).

The setting value update unit 26 reflects the setting value (step S317). Specifically, the setting value update unit 26 deletes the corresponding record of the temporary update information 800. Thus, the temporarily updated setting value is permanently reflected.

When a certain time period (a predetermined time period set in advance) has elapsed since the setting update date and time without pressing of any of the clear button 941 or the reflect button 942, the setting value update unit 26 clears the setting value (step S318). For example, the predetermined time period is set by the user, the administrator, or a designer. In this case, specifically, the setting value update unit 26 performs a process in substantially the same manner as described above with reference to step S314. This prevents a permanent update of a setting value when no operation by the administrator 3 is performed, whereby enhancing safety.

The image forming system 1 according to the present embodiment displays the help screen including the help content and either one of the reference information or the input field. The reference information is information for causing a screen to transition to a setting screen that receives an update of a setting value relating to a setting item relating to the help content and other than a target function. The input field is a field to which the setting value is entered. This reduces efforts for configuring settings other than a function to be supported by the help screen.

Further, if a setting of a function other than a target function to be supported by the help screen is configurable, there is a possibility that a setting value is changed while the administrator does not recognize the change. To address such as issue, when a setting is updated by a user who has no administrator authorization, a temporary update is made available, whereby enhancing convenience. Further, an opportunity is provided for the administrator to determine whether to reflect the temporary update, whereby ensuring safety.

The apparatuses or devices described in each embodiment are merely one example of multiple computing environments that implement one or more embodiments disclosed herein. In some embodiments, the image forming apparatus 20 includes multiple computing devices, such as a server cluster. The multiple computing devices are configured to communicate with one another through any type of communication link, including a network, shared memory, etc., and perform the processes disclosed herein.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

Further, in the embodiments, the description given above is of an example in which the image forming apparatus 20 is an example of an information processing apparatus. The image forming apparatus is merely one example of the information processing apparatus, and any other apparatus suffice, provided that it has an information processing function. Other examples of the information processing apparatus include an output device such as a projector (PJ) and a digital signage, a remote conferencing apparatus, a head-up display (HUD), an industrial machine, a medical device, a networked home appliance, an automobile (connected car), a laptop computer, a mobile phone, a tablet terminal, a game console, a personal digital assistant (PDA), a digital camera, a spherical panoramic imaging device, a wearable personal computer (PC), and a desktop PC.

Further, an application program installed on the image forming apparatus 20 may be installed on an information processing apparatus including a PC, a portable terminal, and a smartphone, which are owned by a user. Accordingly, the operation unit 22 may be provided separately from the image forming apparatus 20.

In conventional arts, on a help screen for a first function, only a shortcut is displayed that, when pressed, causes a current screen to transition to a setting screen of the first function. In other words, for example, a shortcut that causes a current screen to transition to a setting screen for a second function is not displayed, the second function being different from the first function, and including a function of a main unit of the apparatus.

According to one or more embodiments of the present disclosure, information for receiving settings relating to a second function that is different from a first function is displayed on a help screen for the first function.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing apparatus comprising circuitry configured to:
display a help screen including help content relating to a first function and information for receiving a setting relating to a second function, which is different from the first function; and
update a setting value of the second function in response to the received setting.

2. The information processing apparatus of claim 1, wherein
the information for receiving the setting relating to the second function is either one of reference information and an input field, the reference information being information for causing a screen to transition to a setting screen that receives the setting relating to the second function, the input field being a field to which the setting value relating to the second function is input.

3. The information processing apparatus of claim 2, wherein
the information for receiving the setting relating to the second function is the reference information for causing the screen to transition to the setting screen that receives the setting relating to the second function, and
in response to receiving an operation of selecting the reference information, the circuitry displays the setting screen that receives an input to only a setting item relating to the help content.

4. The information processing apparatus of claim 1, wherein
the setting relating to the second function includes a setting of a main unit of the information processing apparatus.

5. The information processing apparatus of claim 1, wherein
the circuitry records temporary update information indicating that the setting value is temporarily updated, when the setting value is updated in response to an input by a user who has no administrator authorization.

6. The information processing apparatus of claim 5, wherein
the circuitry transmits a notification indicating the temporary update information to another user who has the administrator authorization.

7. The information processing apparatus of claim 6, wherein
the circuitry performs either one of a process of changing the setting value to a previous setting value and a process of permanently reflecting the setting value in accordance with a result of a selection made by the second user.

8. The information processing apparatus of claim 7, wherein
the circuitry changes the setting value to the previous setting value when a certain time period has elapsed without receiving the result of the selection since the temporary update information is recorded.

9. A display method comprising:
displaying a help screen including help content relating to a first function and information for receiving a setting relating to a second function, which is different from the first function; and
updating a setting value of the second function in response to the received setting.

10. A non-transitory computer-executable medium storing a program storing instructions which, when executed by a computer, causes the computer to perform a display method, the display method comprising:
display a help screen including help content relating to a first function and information for receiving a setting relating to a second function, which is different from the first function; and
update a setting value of the second function in response to the received setting.
